(19) United States
(12) Patent Application Publication
(10) Pub. No.: US 2025/0173941 A1
(43) Pub. Date: May 29, 2025

(54) METHOD AND AUGMENTED REALITY DEVICE FOR PROVIDING AUGMENTED REALITY OPERATING INSTRUCTIONS FOR OPERATING AN APPARATUS

(71) Applicants: Tsung-Hsiu YU, Tainan City (TW); Chun-Ching WANG, Tainan City (TW); Shih-Wei CHEN, Kaohsiung City (TW)

(72) Inventors: Tsung-Hsiu YU, Tainan City (TW); Chun-Ching WANG, Tainan City (TW); Shih-Wei CHEN, Kaohsiung City (TW)

(21) Appl. No.: 18/957,196

(22) Filed: Nov. 22, 2024

(30) Foreign Application Priority Data
Nov. 24, 2023 (TW) 112145466

(51) Int. Cl. G06T 13/40; G06T 7/246; G06T 7/73; G06T 17/20; G06V 20/20; G06V 20/80

(52) U.S. Cl. CPC G06T 13/40; G06T 7/251; G06T 7/74; G06T 17/20; G06V 20/20; G06V 20/80; G06T 2200/24; G06T 2207/30196; G06T 2210/56

(57) ABSTRACT

A method for providing a set of augmented reality (AR) operating instructions for operating an apparatus, the apparatus having a two-dimensional (2D) barcode disposed thereon. The method is implemented using an AR device and includes steps of: capturing an image of the 2D barcode to obtain three-dimensional (3D) animation data associated with the AR operating instructions; obtaining a location of the 2D barcode and an orientation of the 2D barcode based on the image of the 2D barcode, the location of the 2D barcode being defined with respect to a 3D coordinate system using the AR device as a spatial anchor, the orientation indicating a direction in which the 2D barcode faces with respect to the 3D coordinate system; and presenting the AR operating instructions based on the location of the 2D barcode, the orientation of the 2D barcode and the 3D animation data.

### CROSS-REFERENCE TO RELATED APPLICATION

This application claims priority to Taiwanese Invention patent application No. 112145466, filed on Nov. 24, 2023, the entire disclosure of which is incorporated by reference herein.

### FIELD

The disclosure relates to a method and a device for providing operating instructions for operating an apparatus, and more particularly to a method and an augmented reality (AR) device for providing a set of AR operating instructions for operating an apparatus.

### BACKGROUND

The technique of augmented reality (AR) involves using a camera to capture real-world images, and then, combined with certain positioning techniques, presenting virtual objects that are superimposed onto real-world scenes on a screen of an AR device (e.g., a pair of AR glasses). As such, a user is able to view AR content that combines real-world scenes and virtual objects.

AR includes applications that are capable of inserting information into the real-world scenes in a highly visualized and situated manner, and are effective in connecting AR content to work situations, increasing work efficiency, and providing experiences that expand beyond the screen. One such application of AR is presenting interactive instructions as virtual objects, so as to provide guidance interactively to users of the AR devices.

### SUMMARY

It is also beneficial for AR devices, in cases where specific instructions are to be presented, to be able to quickly obtain the corresponding virtual object and to quickly determine a desired location in the real-world scene where the virtual object is to be presented. Additionally, typically in establishing a virtual coordinate system for projecting virtual objects, a spatial anchor (e.g., a real life object that remains still) is needed as a reference.

Therefore, an object of the disclosure is to provide a method for providing a set of augmented reality (AR) operating instructions for operating an apparatus.

According to one embodiment of the disclosure, the apparatus has a two-dimensional (2D) barcode disposed thereon. The 2D barcode contains link information that is for accessing three-dimensional (3D) animation data associated with the AR operating instructions. The 3D animation data is associated with a first 3D coordinate system that uses the 2D barcode as a spatial anchor. The method is implemented using an AR device that includes a camera, a processor and a presenting interface. The method includes the steps of:
a) capturing, by the camera, an image of the 2D barcode;
b) reading, by the processor, the 2D barcode to obtain the link information, and using the link information to obtain the 3D animation data;
c) obtaining, by the processor, a location of the 2D barcode and an orientation of the 2D barcode based on the image of the 2D barcode, the location of the 2D barcode being defined with respect to a second 3D coordinate system, the orientation indicating a direction in which the 2D barcode faces with respect to the second 3D coordinate system, the second 3D coordinate system using the AR device as a spatial anchor; and
d) presenting, via the presenting interface, the AR operating instructions based on the location of the 2D barcode, the orientation of the 2D barcode and the 3D animation data.

Another object of the disclosure is to provide an augmented reality (AR) device that is capable of implementing the above-mentioned method.

According to one embodiment of the disclosure, the apparatus has a two-dimensional (2D) barcode disposed thereon. The 2D barcode containing link information that is for accessing three-dimensional (3D) animation data associated with the AR operating instructions. The 3D animation data being associated with a first 3D coordinate system that uses the 2D barcode as a spatial anchor. The AR device includes a camera that captures an image of the 2D barcode, a processor and a presenting interface.

The processor reads the 2D barcode to obtain the link information, and uses the link information to obtain the 3D animation data, and obtains a location of the 2D barcode and an orientation of the 2D barcode based on the image of the 2D barcode. The location of the 2D barcode is defined with respect to a second 3D coordinate system. The orientation indicating a direction in which the 2D barcode faces with respect to the second 3D coordinate system. The second 3D coordinate system using the AR device as a spatial anchor.

The presenting interface presents the AR operating instructions based on the location of the 2D barcode, the orientation of the 2D barcode and the 3D animation data.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating components of an augmented reality (AR) system according to one embodiment of the disclosure.

FIG. 2 illustrates an exemplary two-dimensional (2D) barcode being disposed on an apparatus according to one embodiment of the disclosure.

FIG. 3 illustrates a first three-dimensional (3D) coordinate system with the 2D barcode as a spatial anchor.

FIG. 4 is a flow chart illustrating steps of an exemplary method for providing a set of AR operating instructions for operating the apparatus according to one embodiment of the disclosure.

FIG. 5 illustrates the sub-steps of presenting the AR operating instructions according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

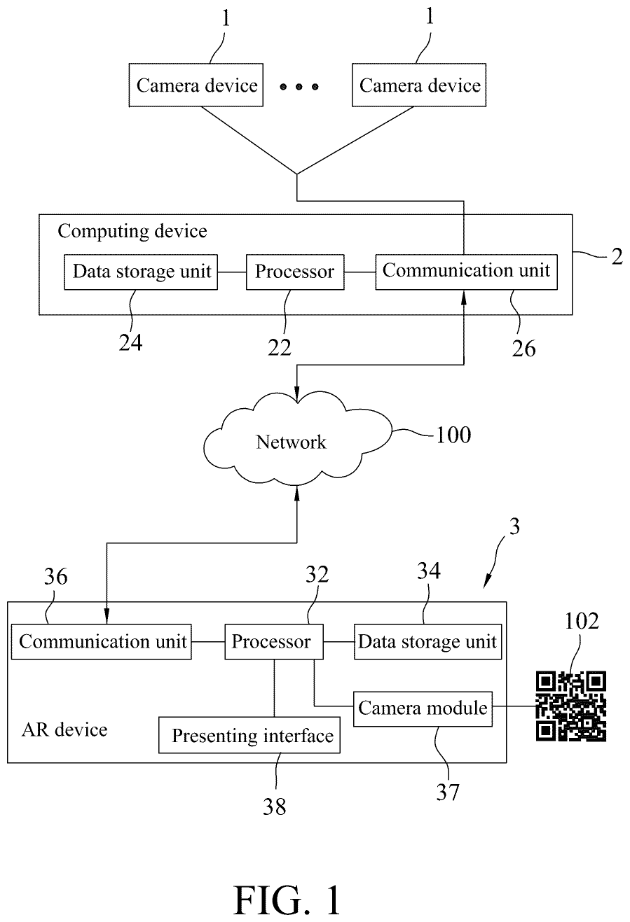

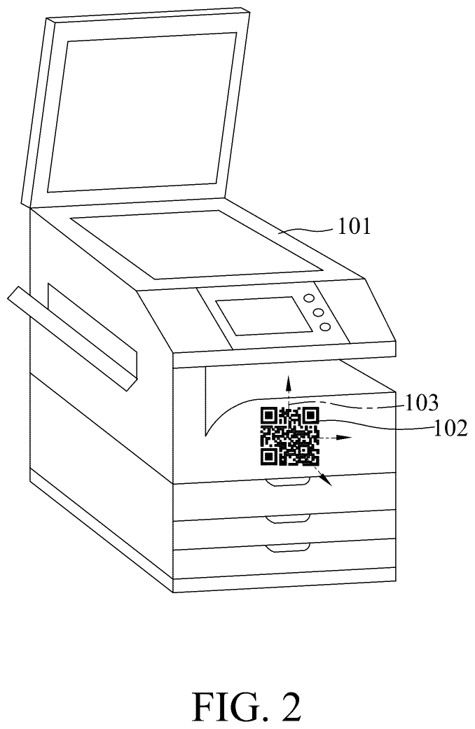

FIG. 1 is a block diagram illustrating components of an augmented reality (AR) system according to one embodiment of the disclosure. The AR system is used for providing operating instructions for operating an apparatus 101 (shown in FIG. 2), and includes a plurality of camera devices 1, a computing device 2, an AR device 3, and a two-dimensional (2D) barcode 102 disposed on the apparatus 101.

In the embodiment of FIG. 1, two camera devices 1 are present, but additional camera device(s) may be included in other embodiments. The computing device 2 may be embodied using a server, a personal computer, a laptop, a tablet, or other suitable equipment, and includes a processor 22, a data storage unit 24, and a communication unit 26.

The processor 22 may be embodied using one or more of a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application-specific integrated circuit (ASIC), a radio-frequency integrated circuit (RFIC), etc.

The data storage unit 24 is connected to the processor 22, and may be embodied using, for example, one or more of random access memory (RAM), read only memory (ROM), programmable ROM (PROM), firmware, flash memory, etc.

The communication unit 26 is connected to the processor 22, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like. The communication unit 26 enables the computing device 2 to communicate with the camera devices 1 via a wired connection and with the AR device 3 via a wireless connection (e.g., via a network 100 such as the Internet).

The AR device 3 may be embodied using a smartphone, a laptop, a pair of AR glasses with computing capabilities, a combination of a smartphone and a pair of AR glasses, a combination of a laptop and a pair of AR glasses, etc., and includes a processor 32, a data storage unit 34, a communication unit 36, a camera module 37, and a presenting interface 38.

Each of the processor 32, the data storage unit 34, and the communication unit 36 of the AR device 3 may be embodied using components that are similar to the processor 22, the data storage unit 24 and the communication unit 26 of the computing device 2, respectively. The camera module 37 may include one or more cameras disposed on the AR device 3. The presenting interface 38 may be a touch screen on the smartphone, a display screen on the laptop, or the lenses on the AR glasses.

FIG. 2 illustrates an exemplary 2D barcode 102 disposed on the apparatus 101 according to one embodiment of the disclosure. The 2D barcode 102 is disposed on a pre-determined location on the apparatus 101. In one embodiment, the apparatus 101 may be a printer or other equipment whose users may need guidance on how to operate the equipment, and the 2D barcode 102 may be printed or etched onto the pre-determined location on the apparatus 101. In the disclosure, it is sought to provide a set of AR operating instructions for operating the apparatus 101 for a user operating the AR device 3 (shown in FIG. 1).

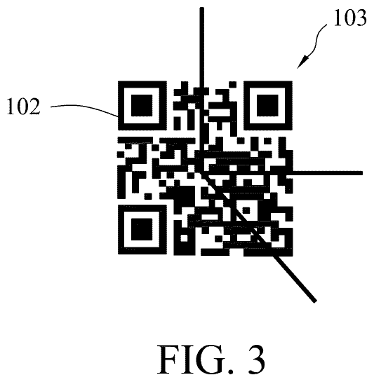

Referring to FIGS. 2 and 3, the 2D barcode 102 may be a Quick Response (QR) code or other variations, and contains link information that is for accessing three-dimensional (3D) animation data associated with a set of AR operating instructions. The 3D animation data is also associated with a first 3D coordinate system 103 that uses the 2D barcode 102 as a spatial anchor. FIG. 3 illustrates the first 3D coordinate system 103 with the 2D barcode 102 as a spatial anchor. In embodiments, the link information includes a hyperlink for downloading the 3D animation data.

Referring back to FIGS. 1 and 2, the data storage unit 24 of the computing device 2, which is external to the AR device 3, stores a plurality of identification codes and a plurality of entries of 3D animation data that correspond with the plurality of identification codes, respectively. The data storage unit 24 further stores a plurality of entries of dimensional data that correspond with different 2D barcodes 102, respectively, and that each indicate several of dimensions (e.g., a length, a width, etc.) of a corresponding one of the 2D barcodes 102. In embodiments, different kinds of apparatuses 101 (e.g., printers, fax machines, etc.) may be used, and the link information contained in the 2D barcode 102 disposed on an individual one of the kinds of apparatuses 101 includes an encoded identification code associated with the apparatus 101. That is to say, each of the plurality of entries of 3D animation data may correspond with a set of AR operating instructions associated with one of the kinds of apparatuses 101.

Each of the plurality of entries of 3D animation data is to be presented in a second 3D coordinate system, and includes a bipedal skeleton dataset that includes a plurality of entries of bipedal skeleton data, a default humanoid 3D mesh model, and a skin weight dataset that corresponds with the default humanoid 3D mesh model.

Each of the entries of bipedal skeleton data includes location information regarding locations of multiple bones included in a bipedal skeleton (which may be human skeleton), and orientation information regarding orientations of the multiple bones included in the bipedal skeleton. The default humanoid 3D mesh model includes a plurality of grids, each of the plurality of grids being composed using a plurality of vertices. Each of the plurality of vertices is associated with one of the multiple bones included in the bipedal skeleton. The skin weight dataset includes a plurality of skin weights. Each of the plurality of skin weights corresponds with one of the plurality of vertices (and, in turn, a corresponding one of the multiple bones), and indicates an influence of the corresponding one of the multiple bones on the one of the plurality of vertices for rendering 3D models.

In some embodiments, an entry of the 3D animation data may be obtained by first activating the camera devices 1 to capture an operating scene that contains an operator operating a specific kind of apparatus 101 with the 2D barcode 102 thereon. The operator may wear a costume with a number of markers that are visible to the camera devices 1 and that indicate joints of the operator. In the embodiment of FIG. 1, the operation of each of the two camera devices 1 yields an operating video that includes the operating scene, resulting in two operating videos. It is noted that the actions of the operator operating the apparatus 101 as captured in the operating videos are used as a basis to generate the AR operating instructions, in order to provide visualized instructions to the user.

Then, the computing device 2 processes the two operating videos to calculate, for each of the markers, a set of real-world coordinates in a global coordinate system. The calculation may be implemented by the processor 22 using methods described in the documents “Y. Cai and G. Medioni, “Exploring context information for inter-camera multiple target tracking,” IEEE Winter Conferences on Applications of Computer Vision, Steamboat Springs, CO, USA, 2014, pp. 761-768, doi: 10.1109/WACV.2014.6836026″ or “W. Chen, L. Cao, X. Chen and K. Huang, “An Equalized Global Graph Model-Based Approach for Multicamera Object Tracking,” in IEEE Transactions on Circuits and Systems for Video Technology, vol. 27, no. 11, pp. 2367-2381 November 2017, doi: 10.1109/TCSVT.2016.2589619″.

Then, the processor 22 converts each of the sets of real-world coordinates into a respective set of converted coordinates in the first 3D coordinate system 103 so as to obtain a plurality of sets of converted coordinates that correspond with the markers, respectively, and generates the entry of bipedal skeleton data based on the plurality of sets of converted coordinates using, for example, commercially available software applications such as MotionBuilder.

It is noted that the above operations may be repeated multiple times for different kinds of apparatuses 101 to obtain the plurality of entries of bipedal skeleton data that constitute the bipedal skeleton dataset of the 3D animation data.

In some embodiments, in addition to the bipedal skeleton dataset, the default humanoid 3D mesh model, and the skin weight dataset that corresponds with the default humanoid 3D mesh model, the 3D animation data may further include other information for enhancing the AR operating instructions. For example, the 3D animation data may further include component shapes that indicate shapes of a plurality of components of the apparatus 101, and a plurality of locations and a plurality of orientations that correspond with locations and orientations of the plurality of components of the apparatus 101, respectively. Accordingly, in obtaining the 3D animation data, the apparatus 101 may be placed with additional markers on different components, and in processing the resulting operating videos, the movements of the components of the apparatus 101 while being operated may also be determined. This configuration is particularly useful in cases where the components of the apparatus 101 move while being operated. Afterward, the 3D animation data for different kinds of apparatuses 101 may be stored in the data storage unit 24 or other locations (e.g., a cloud server), and therefore may be accessed using the link information contained in the 2D barcode 102.

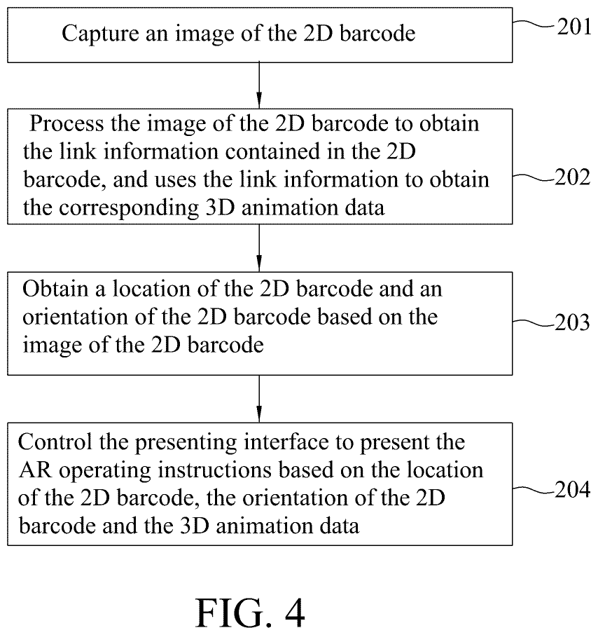

Afterwards, when a user operating the AR device 3 intends to learn how to operate an apparatus 101, he/she may interact with the 2D barcode 102 for initiating a method for providing a set of AR operating instructions for operating the apparatus 101. FIG. 4 is a flow chart illustrating steps of an exemplary method for providing the set of AR operating instructions for operating the apparatus 101 according to one embodiment of the disclosure.

In step 201, the user positions the AR device 3 to face the 2D barcode 102, and activates the camera module 37 to capture an image of the 2D barcode 102. In the embodiment of FIG. 2, the operation of step 201 involves the camera module 37 obtaining an image of the QR code.

In step 202, the processor 32 processes the image of the 2D barcode 102 to obtain the link information contained in the 2D barcode 102, and uses the link information to obtain the corresponding 3D animation data.

In some embodiments, the link information includes a hyperlink for downloading the 3D animation data, and step 202 includes the processor 32 accessing the hyperlink to download the 3D animation data.

In some embodiments where the computing device 2 stores the plurality of identification codes and the plurality of entries of 3D animation data that correspond with the plurality of identification codes, and the link information further includes the encoded identification code associated with the apparatus 101, step 202 includes the processor 32 obtaining the encoded identification code, transmitting the encoded identification code to the computing device 2 as a request for a corresponding one of the plurality of entries of 3D animation data that corresponds with the identification code matching the encoded identification code, and receiving the corresponding one of the plurality of entries of 3D animation data from the computing device 2.

In some embodiments, the processor 32 further transmits a request for a corresponding one of the plurality of entries of dimensional data that is associated with the 2D barcode 102. Alternatively, the 2D barcode 102 may directly contain an entry of dimensional data that indicates a number of dimensions of the 2D barcode, and the processor 32 may be able to obtain the entry of dimensional data by processing the image of the 2D barcode 102.

In step 203, the processor 32 obtains a location of the 2D barcode 102 and an orientation of the 2D barcode 102 based on the image of the 2D barcode 102. In embodiments, the location of the 2D barcode is defined with respect to the second 3D coordinate system and may be represented using a set of coordinates, and the term “orientation” indicates a direction in which the 2D barcode faces with respect to the second 3D coordinate system. The second 3D coordinate system uses the AR device 3 as a spatial anchor. It is noted that calculations involved in step 203 may be done by the processor 32 executing a commercially available software application, and details thereof are omitted herein for the sake of brevity.

In some embodiments, the operations in step 203 include obtaining the location of the 2D barcode 102 and the orientation of the 2D barcode 102 further based on the corresponding one of the plurality of entries of dimensional data.

Then, in step 204, the processor 32 controls the presenting interface 38 to present the AR operating instructions based on the location of the 2D barcode 102, the orientation of the 2D barcode 102 and the 3D animation data.

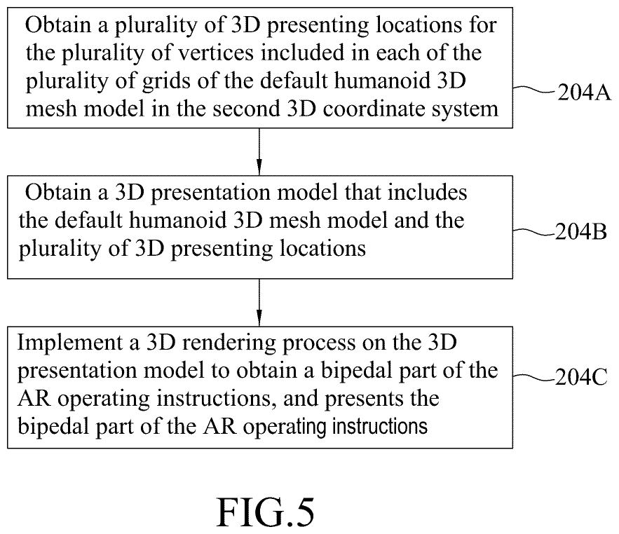

Specifically, the operations in step 204 may include a number of sub-steps. FIG. 5 illustrates the sub-steps of step 204 according to one embodiment of the disclosure.

In sub-step 204A, the processor 32 obtains a plurality of 3D presenting locations for the plurality of vertices included in each of the plurality of grids of the default humanoid 3D mesh model in the second 3D coordinate system. Each of the plurality of 3D presenting locations may be represented using a set of coordinates of the second 3D coordinate system, and may be obtained based on the location of the 2D barcode 102, the orientation of the 2D barcode 102, one of the plurality of entries of the bipedal skeleton data and the skin weight dataset included in the 3D animation data.

In use, the operations of sub-step 204A may include the processor 32 obtaining a transformation matrix between the first 3D coordinate system 103 and the second 3D coordinate system using the location of the 2D barcode 102 and the orientation of the 2D barcode 102 defined with respect to the second 3D coordinate system. Then, the processor 32, using the transformation matrix, transforms the location information and the orientation information included in the bipedal skeleton data to obtain an entry of transformed bipedal skeleton data that includes transformed location information and transformed orientation information for presentation in the second 3D coordinate system. Then, the processor 32 obtains the plurality of 3D presenting locations based on the entry of transformed bipedal skeleton data and the skin weight dataset included in the 3D animation data. It is noted that, since the 2D barcode 102 is fixed onto a predetermined relative location on the apparatus 101, and each specific 2D barcode 102 has a unique set of dimensions, in the case that an image of the 2D barcode 102 is captured by a camera, the location of the camera relative to the apparatus may be calculated, and the transformation matrix between the first 3D coordinate system 103 and the second 3D coordinate system may be calculated with the parameters of the camera module 37 known. For example, using the location of each of the four corners of the 2D barcode 102 included in the image of the 2D barcode 102, a location of the camera module 37 relative to the 2D barcode 102 may be calculated.

In sub-step 204B, the processor 32 obtains a 3D presentation model that includes the default humanoid 3D mesh model and the plurality of 3D presenting locations.

Then, in sub-step 204C, the processor 32 implements a 3D rendering process on the 3D presentation model to obtain a bipedal part of the AR operating instructions, and presents the bipedal part of the AR operating instructions. In use, the bipedal part of the AR operating instructions may be a virtual human character being projected on the presenting interface 38 to “stand” beside the apparatus 101 and operating the apparatus 101.

In some embodiments, as the AR device 3 is presenting the AR operating instructions, the camera module 37 may remain activated, and the processor 32 may utilize a simultaneous localization and mapping (SLAM) algorithm to continuously obtain the location of the 2D barcode 102 and the orientation of the 2D barcode 102 based on the images of the 2D barcode 102 captured by the camera module 37. Then, the above-described operations included in steps 203 and 204 may be repeated to adjust the AR operating instructions (e.g., adjust the location on the presenting interface 38 where the virtual human character is being projected on). This is particularly useful in the case where a spatial relationship between the 2D barcode 102 and the camera module 37 of the AR device 3 changes as the AR device 3 is presenting the AR operating instruction (e.g., when the user moves around the apparatus 101 to observe the AR operating instruction in different angles).

It is noted that, during the operations of the above method, the SLAM algorithm may be also implemented with inputs from additional sensors included in the AR device 3 (e.g., a gyroscope, an accelerometer, a light detection and ranging (LIDAR) component, etc.) in order to provide a more accurate calculation for presenting the AR operating instruction. As such, in some embodiments, the AR device 3 including the above sensors may be operational with the above method, even when the camera module 37 including only one single camera.

To sum up, the embodiments of the disclosure provide a method and a system for providing an augmented reality (AR) operating instruction for operating an apparatus. The system includes a two-dimensional (2D) barcode disposed on a predetermined location of the apparatus, therefore the 2D barcode itself may be utilized as a spatial anchor for establishing a first 3D coordination system. When a user operating an AR device to interact with the 2D barcode, 3D animation data associated with operating the apparatus may be obtained by the AR device via the link information contained in the 2D barcode, and the AR device is configured to transform 3D animation data (originally associated with the first 3D coordination system) into transformed 3D animation data associated with a second 3D coordination system using the AR device as a spatial anchor. Therefore, the AR device is configured to present the AR operating instruction based on the location of the 2D barcode, the orientation of the 2D barcode and the 3D animation data.

It is noted that by utilizing the 2D barcode disposed on the apparatus as a spatial anchor for the first 3D coordination system, the method may be initiated regardless of the real-world location of the apparatus, as no additional spatial anchor is needed.

According to one embodiment of the disclosure, there is provided an augmented reality (AR) device that includes a processor with computational capabilities and that stores a software application including instructions that, when executed by the processor, cause the processor to implement the method as described above and shown in FIGS. 4 and 5. The AR device includes a camera that captures an image of a 2D barcode, a processor and a presenting interface.

The processor reads the 2D barcode to obtain the link information, and uses the link information to obtain the 3D animation data, and obtains a location of the 2D barcode and an orientation of the 2D barcode based on the image of the 2D barcode. The location of the 2D barcode is defined with respect to a second 3D coordinate system. The orientation indicating a direction in which the 2D barcode faces with respect to the second 3D coordinate system. The second 3D coordinate system using the AR device as a spatial anchor. The presenting interface presents the AR operating instructions based on the location of the 2D barcode, the orientation of the 2D barcode and the 3D animation data.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for providing a set of augmented reality (AR) operating instructions for operating an apparatus, the apparatus having a two-dimensional (2D) barcode disposed thereon, the 2D barcode containing link information that is for accessing three-dimensional (3D) animation data associated with the AR operating instructions, the 3D animation data being associated with a first 3D coordinate system that uses the 2D barcode as a spatial anchor, the method being implemented using an AR device that includes a camera, a processor and a presenting interface, and comprising steps of:
a) capturing, by the camera, an image of the 2D barcode;
b) reading, by the processor, the 2D barcode to obtain the link information, and using the link information to obtain the 3D animation data;
c) obtaining, by the processor, a location of the 2D barcode and an orientation of the 2D barcode based on the image of the 2D barcode, the location of the 2D barcode being defined with respect to a second 3D coordinate system, the orientation indicating a direction in which the 2D barcode faces with respect to the second 3D coordinate system, the second 3D coordinate system using the AR device as a spatial anchor; and
d) presenting, via the presenting interface, the AR operating instructions based on the location of the 2D barcode, the orientation of the 2D barcode and the 3D animation data.

2. The method as claimed in claim 1, the link information including a hyperlink for downloading the 3D animation data, wherein step b) includes the processor accessing the hyperlink to download the 3D animation data.

3. The method as claimed in claim 1, the AR device being connected to a computing device that stores a plurality of identification codes and a plurality of entries of 3D animation data that correspond with the plurality of identification codes, respectively, the link information including an encoded identification code associated with the apparatus, wherein step b) includes the processor obtaining the encoded identification code, transmitting the encoded identification code to the computing device as a request for a corresponding one of the plurality of entries of 3D animation data, and receiving the corresponding one of the plurality of entries of 3D animation data from the computing device.

4. The method as claimed in claim 3, the computing device further storing a plurality of entries of dimensional data that correspond with different 2D barcodes, respectively and that each indicate a number of dimensions of a corresponding one of 2D barcodes, wherein:
step b) further includes transmitting a request for a corresponding one of the plurality of entries of dimensional data; and
step c) includes obtaining the location of the 2D barcode and the orientation of the 2D barcode further based on the corresponding one of the plurality of entries of dimensional data.

5. The method as claimed in claim 1, the 2D barcode further containing an entry of dimensional data that indicates a number of dimensions of the 2D barcode, wherein:
step b) includes obtaining the entry of dimensional data from the image of the 2D barcode; and
step c) includes obtaining the location of the 2D barcode and the orientation of the 2D barcode further based on the entry of dimensional data.

6. The method as claimed in claim 1, the 2D barcode being a quick response (QR) code, wherein step a) includes the camera obtaining an image of the QR code.

7. The method as claimed in claim 1, the 3D animation data including a bipedal skeleton dataset that includes a plurality of entries of bipedal skeleton data, a default humanoid 3D mesh model and a skin weight dataset that corresponds with the default humanoid 3D mesh model, the default humanoid 3D mesh model including a plurality of grids, each of the plurality of grids being composed using a plurality of vertices, wherein step d) includes:
obtaining a plurality of 3D presenting locations for the plurality of vertices included in each of the plurality of grids of the default humanoid 3D mesh model in the second 3D coordinate system, based on the location of the 2D barcode, the orientation of the 2D barcode, one of the plurality of entries of biped skeleton data and the skin weight dataset included in the 3D animation data;
obtaining a 3D presentation model that includes the default humanoid 3D mesh model and the plurality of 3D presenting locations; and
implementing a 3D rendering process on the 3D presentation model to obtain a bipedal part of the AR operating instructions, and presenting the bipedal part of the AR operating instructions.

8. An augmented reality (AR) device for providing a set of augmented reality (AR) operating instructions for operating an apparatus, the apparatus having a two-dimensional (2D) barcode disposed thereon, the 2D barcode containing link information that is for accessing three-dimensional (3D) animation data associated with the AR operating instructions, the 3D animation data being associated with a first 3D coordinate system that uses the 2D barcode as a spatial anchor, the AR device comprising:
a camera that captures an image of the 2D barcode;
a processor that
reads the 2D barcode to obtain the link information, and uses the link information to obtain the 3D animation data, and
obtains a location of the 2D barcode and an orientation of the 2D barcode based on the image of the 2D barcode, the location of the 2D barcode being defined with respect to a second 3D coordinate system, the orientation indicating a direction in which the 2D barcode faces with respect to the second 3D coordinate system, the second 3D coordinate system using the AR device as a spatial anchor; and
a presenting interface that presents the AR operating instructions based on the location of the 2D barcode, the orientation of the 2D barcode and the 3D animation data.

9. The AR device as claimed in claim 8, the link information including a hyperlink for downloading the 3D animation data, wherein, the processor accesses the hyperlink to download the 3D animation data.

10. The AR device as claimed in claim 8, being connected to a computing device that stores a plurality of identification codes and a plurality of entries of 3D animation data that correspond with the plurality of identification codes, respectively, the link information including an encoded identification code associated with the apparatus, wherein:
the processor obtains the encoded identification code, transmits the encoded identification code to the computing device as a request for a corresponding one of the plurality of entries of 3D animation data, and receives the corresponding one of the plurality of entries of 3D animation data from the computing device.

11. The AR device as claimed in claim 10, the computing device further storing a plurality of entries of dimensional data that correspond with different 2D barcodes, respectively, and that each indicate a number of dimensions of a corresponding one of 2D barcodes, wherein:
the processor further transmits a request for a corresponding one of the plurality of entries of dimensional data, and obtains the location of the 2D barcode and the orientation of the 2D barcode further based on the corresponding one of the plurality of entries of dimensional data.

12. The AR device as claimed in claim 8, the 2D barcode further containing an entry of dimensional data that indicates a number of dimensions of the 2D barcode, wherein:
the processor obtains the entry of dimensional data from the image of the 2D barcode; and obtains the location of the 2D barcode and the orientation of the 2D barcode further based on the entry of dimensional data.

13. The AR device as claimed in claim 8, the 2D barcode being a quick response (QR) code, wherein the camera obtains an image of the QR code.

14. The AR device as claimed in claim 8, the 3D animation data including a biped skeleton dataset that includes a plurality of entries of biped skeleton data, a default humanoid 3D mesh model and a skin weight dataset that corresponds with the default humanoid 3D mesh model, the default humanoid 3D mesh model including a plurality of grids, each of the plurality of grids being composed using a plurality of vertices, wherein:
the processor obtains a plurality of 3D presenting locations for the plurality of vertices included in each of the plurality of grids of the default humanoid 3D mesh model in the second 3D coordinate system, based on the location of the 2D barcode, the orientation of the 2D barcode, one of the plurality of entries of bipedal skeleton data and the skin weight dataset included in the 3D animation data, obtains a 3D presentation model that includes the default humanoid 3D mesh model and the plurality of 3D presenting locations, and implements a 3D rendering process on the 3D presentation model to obtain a biped part of the AR operating instructions; and
the presenting interface presents the biped part of the AR operating instructions.
